(19) United States
(12) Patent Application Publication
(10) Pub. No.: US 2006/0139500 A1
(43) Pub. Date: Jun. 29, 2006

(54) Television control system and method

(75) Inventors: Stephen Zhou, Taipei (TW); Chaucer Chiu, Taipei (TW)

Correspondence Address: PEARL COHEN ZEDEK, LLP, 1500 BROADWAY 12TH FLOOR, NEW YORK, NY, 10036, US

(73) Assignee: INVENTEC CORPORATION

(21) Appl. No.: 11/022,851

(22) Filed: Dec. 28, 2004

(51) Int. Cl. H04N 5/44; H04N 5/63

(52) U.S. Cl. 348/730; 348/553

(57) ABSTRACT

A television control system and method is proposed. First of all, a first time recording module serves to record time once a television is switched on. Then, a first comparing module serves to compare a result of time recorded by the first time recording module to a first preset time, and send out an actuation signal if the result of time recorded by the first time recording module is longer than the first preset time. Subsequently, a second time recording module serves to record time upon receiving the actuation signal and display a power off message on a display of the television. Finally, a second comparing module serves to compare a result of time recorded by the second time recording module to a second preset time and send out a power off signal to a power off module to switch off power of the television if the result of time recorded by the second time recording module is longer than the second preset time. Therefore, operation of the television can be controlled depending on personal requirements of a user while avoiding waste of energy and maintaining a living quality for the user.

### FIELD OF THE INVENTION

The present invention relates to television control systems and methods, and more particularly, to a system and method for controlling power supply of a television.

### BACKGROUND OF THE INVENTION

Nowadays, television has become a very widespread technological product and watching television programs is a principal leisure time activity in one's daily life. Data transmission via television cable provides a fast way to deliver a large amount of information and is unlimited by distances, such that users are able to watch a wide variety of television programs and the latest news, and acquire knowledge. Particularly, watching entertaining television programs has become an important recreation in many people's leisure time.

However, the user, especially an elder audience, sometimes falls asleep while watching the television program. A situation that the television program is still turned on in a loud volume at midnight until the user wakes up might cause many troubles in the user's daily life.

First of all, energy is wasted if the television is switched on without being watched. One might pay no attention to such situation. However, as the living quality nowadays is far improved than before, there might be several televisions owned by a family, such that the wasted energy accumulated would be of concerns. Secondly, if the television is operated in a loud volume at midnight, other family members or even neighbors might be disturbed as a small sound could become very obvious in a quiet environment. Thirdly, the health of the user might be influenced as a sleeping quality might be affected if the user sleeps in a noisy environment. Finally, a service life of the television, particularly a plasma display panel (PDP), might be shortened if the television is operated over a long period of time without being switched off.

Furthermore, the current television normally has a timing power off function for one to set a time for automatically switching off the television before going to asleep. However, one cannot determine whether he or she will fall asleep during the preset period of time. Thus, the timing power off function cannot completely eliminate the foregoing drawbacks.

The problem to be solved here, therefore, is to provide a television control system and method, by which operation of the television can be controlled by the user depending on personal requirements, so as to avoid waste of energy while maintaining the living quality for the user.

### SUMMARY OF THE INVENTION

In light of the above prior-art drawbacks, a primary objective of the present invention is to provide a television control system and method, by which a television can itself automatically switch off to avoid waste of energy sources if the television has not been used over a certain period of time.

Another objective of the present invention is to provide a television control system and method which does not affect the living quality of a user.

A further objective of the present invention is to provide a television control system and method which is capable of increasing a service life of a television.

In accordance with the above and other objectives, the present invention proposes a television control system, comprising a first time recording module, a first comparing module, a second time recording module, and a second comparing module. The first time recording module is configured to start recording time once a television is switched on. The first comparing module is configured to compare a result of time recorded by the first time recording module to a first preset time, and send out an actuation signal if the result of time recorded by the first time recording module is longer than the first preset time. The second lime recording module is configured to receive the actuation signal sent out by the first comparing module, start recording time and display a power off message on a display of the television once the actuation signal has been received. The second comparing module is configured to compare a result of time recorded by the second time recording module to a second preset time, and send out a power off signal if the result of time recorded by the second time recording module is longer than the second preset time.

The television control system further comprises a power off module, a first detecting module, a second detecting module, a setting module, and a memorizing module. The power module is configured to receive the power off signal sent out by the second comparing module and switch off the power of the television according to the signal. The first detecting module is configured to detect whether an action of changing a channel of the television or adjusting a volume of the television is taken. The second detecting module is configured to detect whether any actions are taken by the television or a remote control of the television. The setting module is configured to set up the first preset time and the second preset time. A storage module is configured to store the first preset time and the second preset time. The first preset time and the second present time can be predetermined by a television manufacturer, or alternatively, can be determined by a user depending on personal requirements.

According to the foregoing television control system, the present invention also proposes a television control method. First of all, a first time recording module serves to record time once a television is switched on. Then, a first comparing module serves to compare a result of time recorded by the first time recording module to a first preset time, and send out an actuation signal to actuate a second time recording module if the result of time recorded by the first time recording module is longer than the first preset time. Subsequently, the second time recording module serves to record time and display a power off message on a display of the television once the actuation signal has been received. Finally, a second comparing module serves to compare a result of time recorded by the second time recording module to second preset time, and send out a power off signal to a power off module to switch off power of the television if the result of time recorded by the second time recording module is longer than the second preset time.

The television control method further comprises the following steps. Firstly, a first detecting module is provided to detect whether an action of changing a channel of the television or adjusting a volume of the television is taken. If the first detecting module has detected that the television is changing the channel or adjusting the volume, a reset signal is sent out to the first time recording module, such that the first time recording module can reset its recorded time and restart timing from zero again. Furthermore, a second detecting module is provided to detect whether any actions are taken by the television or a remote control of the television. If the second detecting module has detected any actions taken by the television or the remote control, a reset signal is sent out to the respective first time recording module and the second time recording module, such that the first time recording module and the second time recording module both can restart timing from zero.

In comparison to the television control technique known in the prior art, the television control system and method proposed in the present invention is able to avoid waste of electric energy and increase a service life of the television while maintaining a living quality for the user.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing basic structure of a television control system according to the present invention; and

FIG. 2 is a flowchart showing operation of a television control method according to the present invention.

### DETAILED DESCRIPTION OF THE EMBODIMENTS

The present invention is described hereafter with specific embodiments, so that one with ordinary skill in the art can easily understand other advantages and effects of the present invention from the disclosure of the invention. The present invention may also be implemented and applied according to other embodiments, and the details may be modified based on different viewpoints and applications without departing from the spirit of the invention.

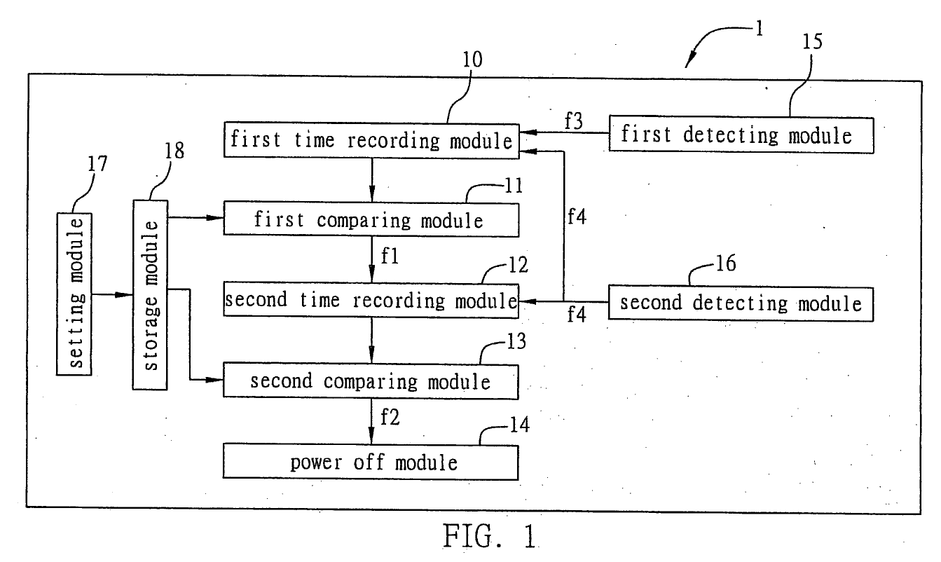

FIG. 1 is a schematic diagram showing basic structure of a television control system 1 according to the present invention. Referring to FIG. 1, the television control system 1 comprises a first time recording module 10 for recording time once a television is switched on; a first comparing module 11 for comparing a result of time recorded by the first time recording module 10 to a first preset time a, and sending out an actuation signal f1 if the result of time recorded by the first time recording module 10 is longer than the first preset time a; a second time recording module 12 for receiving the actuation signal f1 sent out by the first comparing module 11, starting to record time once the actuation signal has been received, and displaying a power off message on a display (not shown) of the television; and a second comparing module 13 for comparing a result of time recorded by the second time recording module 12 to a second preset time b, and sending out a power off signal f2 if the result of time recorded by the second time recording module 12 is longer than the second preset time b.

The television control system 1 further comprises a power off module 14 for receiving the power off signal f2 sent out by the second comparing module 13 and switching off power of the television according to the signal; a first detecting module 15 for detecting whether an action of changing a channel of the television or adjusting a volume of the television is taken, wherein if the first detecting module 15 has detected that the television is performing an operation of changing the channel or adjusting the volume, a reset signal f3 is sent out to the first time recording module 10, such that the first time recording module 10 can reset its timing and restart from zero again; a second detecting module 16 for detecting whether any actions are taken by the television or a remote control of the television, wherein if the second detecting module 16 has detected any actions taken by the television or the remote control, a reset signal f4 is sent out to the first time recording module 10 and the second time recording module 12, such that the first time recording module 10 and the second time recording modules 12 can reset their timings and restart from zero again; a setting module 17 for setting up the first preset time a and the second preset time b; and a storage module 18 for storing the first preset time a and the second preset time b preset via the setting module 17.

The first preset time a and the second present time b can be preset by a television manufacturer according to consumers' lifestyle, or alternatively, can be determined by a user depending on personal requirements.

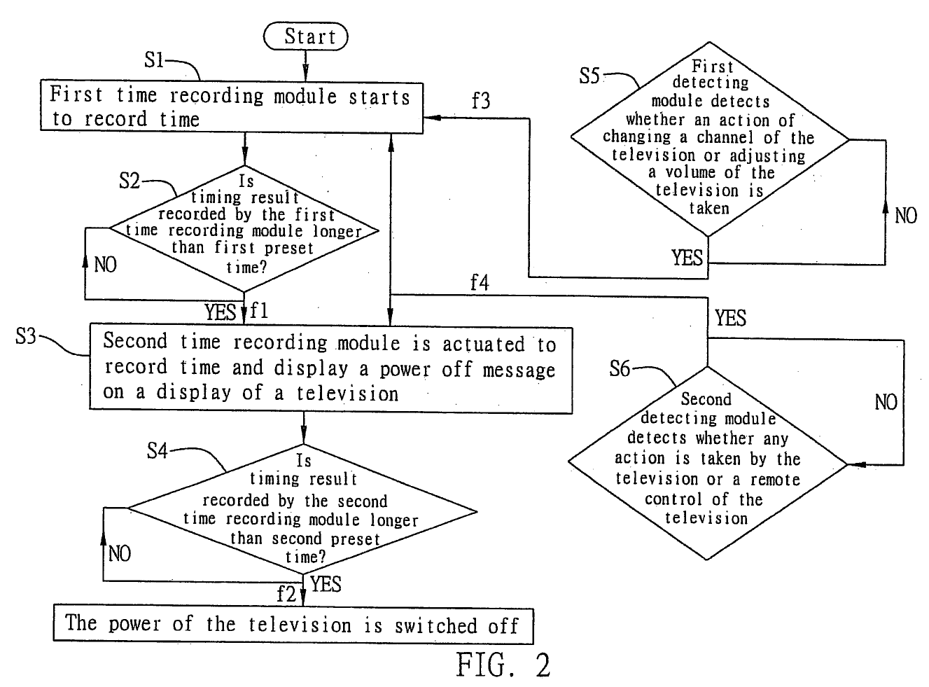

FIG. 2 is a flowchart showing operation of a television control method according to the television control system 1 proposed in present invention. The method comprises the following steps:

In Step S1, the first time recording module 10 starts time recording once a television is switched on, then Step S2 is performed.

In Step S2, the first comparing module 11 compares a result of time recorded by the first time recording module 10 to a first preset time a. If the result of time recorded by the first time recording module 10 is longer than the first preset time a, the first comparing module 11 sends out an actuation signal f1 to actuate a second time recording module 12, then Step S3 is performed. Otherwise, Step S2 is repeated to continue the comparison of the time recorded by the first time recording module 10 to the first preset time a.

In Step S3, the second lime recording module 12 starts time recording once the actuation signal f1 has been received and displays a power off message on a display (not shown) of the television, then Step S4 is performed.

In step S4, the second comparing module 13 compares the result of time recorded by the second time recording module 12 to a second preset time b. If the result of time recorded by the second time recording module 12 is longer than the second preset time b, a power off signal f2 is sent out to the power off module 14 to switch off the power of the television and end the process. Otherwise, Step S4 is repeated to continue comparing the result recorded by the second time recording module 12 to the second preset time b.

The television control method proposed in the present invention further comprises the following steps. In Step S5, the first detecting module 15 serves to detect whether an action of changing a channel of the television or adjusting a volume of the television is taken. If the first detecting module 15 has detected that the television is performing an operation of changing the channel or adjusting the volume, a reset signal f3 is sent out to the first time recording module 10, such that the timing of the first time recording module 10 can be reinitialized. Otherwise, Step S5 is repeated.

In Step S6, the second detecting module 16 detects whether any actions are taken by the television or a remote control of the television. If the second detecting module 16 has detected an action taken by the television or the remote control, a reset signal f4 is sent out to the first time recording module 10 and the second time recording module 12, such that the timings of the first time recording module 10 and the second time recording module 12 are reinitialized. Otherwise, Step S6 is repeated.

The first preset time a and the second present time b can be preset by a television manufacturer, or alternatively, can be determined by a user depending on personal requirements.

In comparison to the television control technique known in the prior art, the television control system and method proposed in the present invention is able to use a timing and comparing mechanism to control the power supply of the television depending on the user's personal requirements. Therefore, waste of electric energy can be avoided and a service life of the television can be increased while maintaining a living quality for the user.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be interpreted to encompass all such modifications and similar arrangements.

What is claimed is:

1. A method for controlling a television, comprising the steps of:
providing a first time recording module for recording time once the television is switched on;
providing a first comparing module for comparing a result of time recorded by the first time recording module to a first preset time, and sending out an actuation signal to actuate a second time recording module if the result of time recorded by the first time recording module is longer than the first preset time;
providing a second time recording module for recording time once the actuation signal has been received and displaying a power off message on a display of the television; and
providing a second comparing module for comparing a result of time recorded by the second time recording module to a second preset time, and sending out a power off signal to a power off module to switch off power of the television if the result of time recorded by the second time recording module is longer than the second preset time.

2. The method of claim 1, further comprising a step of providing a first detecting module for detecting whether an operation of changing a channel of the television or adjusting a volume of the television is taken. If the first detecting module has detected that the television is performing an operation of changing the channel or adjusting the volume, a reset signal is sent out to the first time recording module, such that the first time recording module can reset its timing record.

3. The method of claim 1, further comprising a step of providing a second detecting module for detecting whether any actions are taken by the television or a remote control of the television, if the second detecting module has detected an action taken by the television or the remote control, a reset signal is sent out by the second detecting module to the first time recording module and the second time recording module, such that the first time recording module and the second time recording module can reset their timing records.

4. The method of claim 1, wherein the first preset time and the second preset time are predetermined by a manufacturer.

5. The method of claim 1, wherein the first preset time and the second preset time are determined by a user.

6. A television control system, comprising:
a first time recording module for recording time once a television is switched on;
a first comparing module for comparing a result of time recorded by the first time recording module to a first preset time, and sending out an actuation signal if the result of time recorded by the first time recording module is longer than the first preset time;
a second time recording module for receiving the actuation signal sent out by the first comparing module, starting to record time upon receiving the actuation signal, and displaying a power off message on a display of the television; and
a second comparing module for comparing a result of time recorded by the second time recording module to a second preset time, and sending out a power off signal if the result of time recorded by the second time recording module is longer than the second preset time.

7. The system of claim 6, further comprising a power off module for receiving the power off signal sent out by the second comparing module and switching off power of the television upon receiving the signal.

8. The system of claim 6, further comprising a first detecting module for detecting whether an action of changing a channel of the television or adjusting a volume of the television is taken.

9. The system of claim 8, wherein when the first detecting module has detected that the television is changing the channel or adjusting the volume, a reset signal is sent out to the first time recording module, such that the first time recording module can reset its timing record.

10. The system of claim 6, further comprising a second detecting module for detecting whether any actions are taken by the television or a remote control of the television.

11. The system of claim 10, wherein if the second detecting module has detected any actions taken by the television or the remote control, a reset signal is sent out to the first time recording module and the second time recording module, such that the first time recording module and the second time recording module can reset their timing records.

12. The system of claim 6, further comprising a setting module for setting up the first preset time and the second preset time.

13. The system of claim 12, wherein the first preset time and the second present time are predetermined by a manufacturer.

14. The system of claim 12, wherein the first preset time and the second present time are determined by a user.

15. The system of claim 12, further comprising a storage module for storing the first preset time and the second preset time determined via the setting module.
